(19) United States
(12) Patent Application Publication
(10) Pub. No.: US 2015/0006147 A1
(43) Pub. Date: Jan. 1, 2015

(54) Speech Recognition Systems Having Diverse Language Support

(71) Applicant: Toyota Motor Engineering & Manufacturing North America, Inc., Erlanger, KY (US)

(72) Inventor: Eric Randell Schmidt, Northville, MI (US)

(21) Appl. No.: 13/932,190

(22) Filed: Jul. 1, 2013

(51) Int. Cl. G10L 15/00; G06F 17/28

(52) U.S. Cl. CPC G10L 15/005; G06F 17/289
USPC 704/8

(57) ABSTRACT

A method for providing cross-language automatic speech recognition is provided. The method includes choosing a preferred first language for a speech recognition system. The speech recognition system supports multiple languages. A search operation is initiated using the speech recognition system. A user is prompted to continue the search operation in the first language or a second language. In response to the user selection of continuing in the second language, searching is provided in the second language and interaction is provided with the user in the first language during the search operation.

### FIELD

The disclosure relates to speech recognition systems, and more particularly to speech recognition systems having diverse language support.

### BACKGROUND

Speech recognition systems may be used to receive and process speech input and perform a number of actions based on the speech input. For example, it is common to use speech recognition systems to provide search results based on a spoken search command. In the past, monolingual systems have been provided that recognize a single language (e.g., English or Spanish). More recently, speech recognition systems have been provided where a user can choose a single language preference between multiple available languages.

### SUMMARY

In one embodiment, a method for providing cross-language automatic speech recognition is provided. The method includes choosing a preferred first language for a speech recognition system. The speech recognition system supports multiple languages. A search operation is initiated using the speech recognition system. A user is prompted to continue the search operation in the first language or a second language. In response to the user selection of continuing in the second language, searching is provided in the second language and interaction is provided with the user in the first language during the search operation.

In another embodiment, an automatic speech recognition system provides cross-language automatic speech recognition and includes a computing device including one or more processors and one or more memory components. The computing device includes speech and language logic that, in response to a user initiating a search operation, prompts the user to continue the search operation in a first language or a second language and, in response to the user selection of continuing in the second language, provides searching in the second language and provides interaction with the user in the first language during the search operation.

In another embodiment, a method for providing cross-language automatic speech recognition is provided. The method includes initiating an address search operation using a speech recognition system. The speech recognition system has a preferred first language and supporting at least one other language. A user is prompted to continue the address search operation in the first language or the at least one other language after the address search is initiated. In response to the user selection of continuing in the at least one other language, searching is provided in the at least one other language and providing interaction with the user in the first language.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an interior portion of a vehicle for providing speech recognition, according to one or more embodiments described herein;

FIG. 2 schematically depicts a speech recognition system according to one or more embodiments described herein;

FIG. 3 schematically depicts a vehicle computing device for use in the speech recognition system of FIG. 2 according to one or more embodiments described herein;

FIG. 4 illustrates a usage example illustrating operation of the cross-language ASR capabilities of the speech recognition system of FIG. 1; and

FIG. 5 includes a method of recognizing non-traditional addresses using the speech recognition system of FIG. 1 according to one or more embodiments described herein.

### DETAILED DESCRIPTION

Embodiments described herein are generally directed to speech recognition systems having diverse language support. Such speech recognition systems are configured to handle a variety of inputs, such as multiple languages and formats, and provide desired outputs based on the variety of inputs. As one example, the speech recognition systems may include logic that facilitates searching and other functions in multiple languages without changing language preferences. As another example, the speech recognition systems may include logic that facilitates searching of addresses in non-traditional formats, such as irregular house addresses with dashes or other characters.

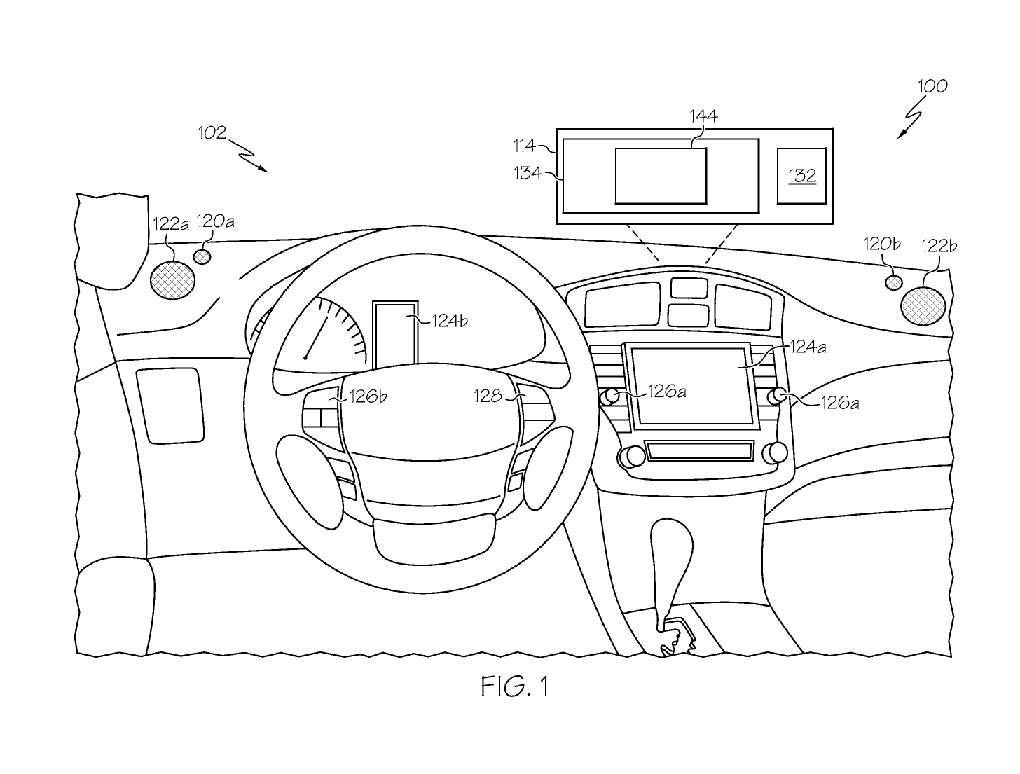

Referring now to the drawings, FIG. 1 schematically depicts an interior portion of a vehicle 102 including a speech recognition system 100, according to embodiments disclosed herein. As illustrated, the vehicle 102 may include a number of components that may provide input to or output from the speech recognition systems 100 described herein. The interior portion of the vehicle 102 includes a console display 124a and a dash display 124b (referred to independently and/or collectively herein as “display 124”). The console display 124a may be configured to provide one or more user interfaces and may be configured as a touch screen and/or include other features for receiving user input. The dash display 124b may similarly be configured to provide one or more interfaces, but often the data provided in the dash display 124b is a subset of the data provided by the console display 124a. Regardless, at least a portion of the user interfaces depicted and described herein may be provided on either or both the console display 124a and the dash display 124b. The vehicle 102 also includes one or more microphones 120a, 120b (referred to independently and/or collectively herein as “microphone 120”) and one or more speakers 122a, 122b (referred to independently and/or collectively herein as “speaker 122”). The one or more microphones 120a, 120b may be configured for receiving user voice commands and/or other inputs to the speech recognition systems described herein. Similarly, the speakers 122a, 122b may be utilized for providing audio content from the speech recognition system to the user. The microphone 120, the speaker 122, and/or related components may be part of an in-vehicle audio system. The vehicle 102 also includes tactile input hardware 126a and/or peripheral tactile input 126b for receiving tactile user input, as will be described in further detail below. The vehicle 102 also includes an activation switch 128 for providing an activation input to the speech recognition system, as will be described in further detail below.

The vehicle 102 also includes a vehicle computing device 114 that can provide computing functions for the speech recognition system 100. The vehicle computing device 114 may include a processor 132 and a memory component 134, which may store speech and language logic 144. The speech and language logic 144 may include a plurality of different pieces of logic, each of which may be embodied as a computer program, firmware and/or hardware, as examples. For example, the speech and language logic 144 may have access to phonetic data saved in the memory component 134 for supporting a variety of languages, such as English, French and Spanish. The speech and language logic 144 may also have access to non-traditional addresses and address formats.

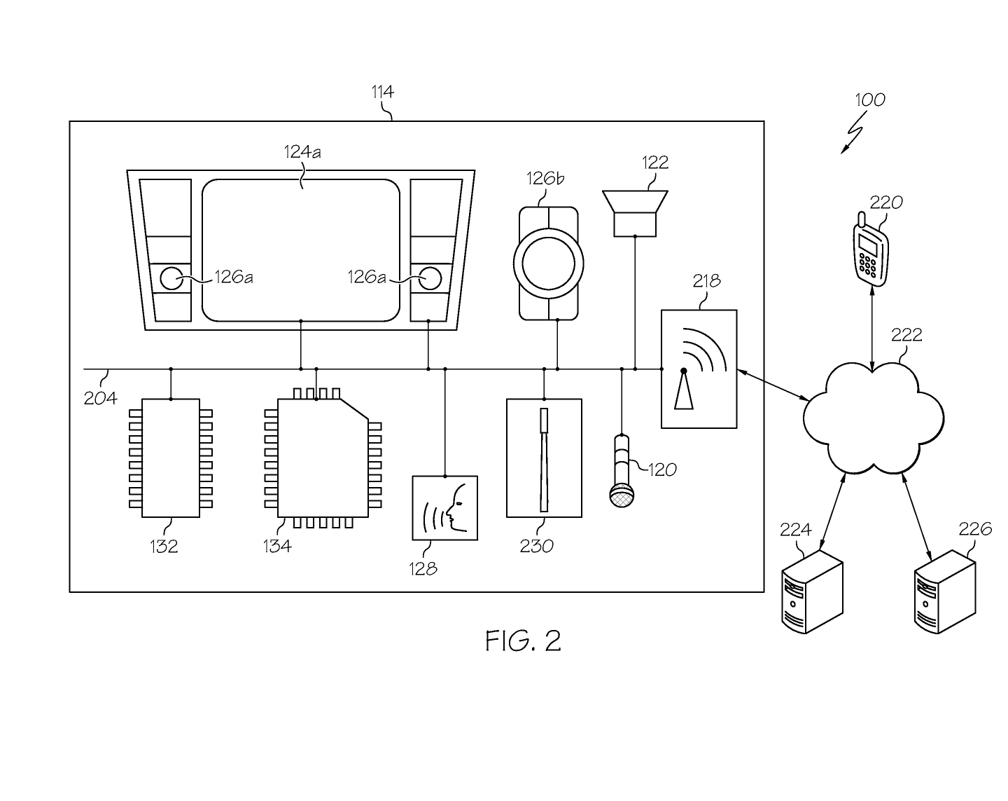

Referring now to FIG. 2, an embodiment of the speech recognition system 100, including a number of the components depicted in FIG. 1, is schematically depicted. It should be understood that the speech recognition system 100 may be integrated with the vehicle 102 or may be embedded within a mobile device (e.g., smartphone, laptop computer, etc.) carried by a driver of the vehicle.

The speech recognition system 100 includes one or more processors 132, a communication path 204, one or more memory components 134, the display 124, the speaker 122, tactile input hardware 126a, the peripheral tactile input 126b, the microphone 120, the activation switch 128, network interface hardware 218, and a satellite antenna 230. The various components of the speech recognition system 100 and the interaction thereof will be described in detail below.

As noted above, the speech recognition system 100 includes the communication path 204. The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the speech recognition system 100. As used herein, the term “communicatively coupled” means that coupled components are capable of exchanging data signals with one another such as, for example, electrical signals via conductive medium, electromagnetic signals via air, optical signals via optical waveguides, and the like.

As noted above, the speech recognition system 100 includes the one or more processors 132. Each of the one or more processors 132 may be any device capable of executing machine readable instructions (e.g., including the speech and language logic). Accordingly, each of the one or more processors 132 may be a controller, an integrated circuit, a microchip, a computer, or any other computing device. The one or more processors 132 are communicatively coupled to the other components of the speech recognition system 100 by the communication path 204. Accordingly, the communication path 204 may communicatively couple any number of processors with one another, and allow the modules coupled to the communication path 204 to operate in a distributed computing environment. Specifically, each of the modules may operate as a node that may send and/or receive data.

As noted above, the speech recognition system 100 includes the one or more memory components 134. Each of the one or more memory components 134 of the speech recognition system 100 is coupled to the communication path 204 and communicatively coupled to the one or more processors 132. The one or more memory components 134 may include RAM, ROM, flash memories, hard drives, or any device capable of storing machine readable instructions such that the machine readable instructions can be accessed and executed by the one or more processors 132. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory components 134. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

In some embodiments, the one or more memory components 134 may include one or more speech recognition algorithms, such as an automatic speech recognition engine that processes speech input signals received from the microphone 120 and/or extracts speech information from such signals, as will be described in further detail below. Furthermore, the one or more memory components 134 may include machine readable instructions that, when executed by the one or more processors 132, cause the speech recognition system 100 to perform the actions described below.

Still referring to FIG. 2, as noted above, the speech recognition system 100 comprises the display 124 for providing visual output such as, for example, information, entertainment, maps, navigation, information, or a combination thereof. The display 124 is coupled to the communication path 204 and communicatively coupled to the one or more processors 132. Accordingly, the communication path 204 communicatively couples the display 124 to other modules of the speech recognition system 100. The display 124 may include any medium capable of transmitting an optical output such as, for example, a cathode ray tube, light emitting diodes, a liquid crystal display, a plasma display, or the like. Moreover, the display 124 may be a touchscreen that, in addition to providing optical information, detects the presence and location of a tactile input upon a surface of or adjacent to the display. Accordingly, each display may receive mechanical input directly upon the optical output provided by the display. Additionally, it is noted that the display 124 can include at least one of the one or more processors 132 and the one or memory components 134. While the speech recognition system 100 includes a display 124 in the embodiment depicted in FIG. 2, the speech recognition system 100 may not include a display 124 in other embodiments, such as embodiments in which the speech recognition system 100 audibly provides outback or feedback via the speaker 122.

The speech recognition system 100 includes the speaker 122 for transforming data signals from the speech recognition system 100 into mechanical vibrations, such as in order to output audible prompts or audible information from the speech recognition system 100. The speaker 122 is coupled to the communication path 204 and communicatively coupled to the one or more processors 132. However, it should be understood that in other embodiments the speech recognition system 100 may not include the speaker 122, such as in embodiments in which the speech recognition system 100 does not output audible prompts or audible information, but instead visually provides output via the display 124.

Still referring to FIG. 2, the speech recognition system 100 includes tactile input hardware 126a coupled to the communication path 204 such that the communication path 204 communicatively couples the tactile input hardware 126a to other modules of the speech recognition system 100. The tactile input hardware 126a may be any device capable of transforming mechanical, optical, or electrical signals into a data signal capable of being transmitted with the communication path 204. Specifically, the tactile input hardware 126a may include any number of movable objects that each transform physical motion into a data signal that can be transmitted to over the communication path 204 such as, for example, a button, a switch, a knob, a microphone or the like. In some embodiments, the display 124 and the tactile input hardware 126a are combined as a single module and operate as an audio head unit or an infotainment system. However, it is noted, that the display 124 and the tactile input hardware 126a may be separate from one another and operate as a single module by exchanging signals via the communication path 204. While the speech recognition system 100 includes tactile input hardware 126a in the embodiment depicted in FIG. 2, the speech recognition system 100 may not include tactile input hardware 126a in other embodiments, such as embodiments that do not include the display 124.

The speech recognition system 100 may include the peripheral tactile input 126b coupled to the communication path 204 such that the communication path 204 communicatively couples the peripheral tactile input 126b to other modules of the speech recognition system 100. For example, in one embodiment, the peripheral tactile input 126b is located in a vehicle console to provide an additional location for receiving input. The peripheral tactile input 126b operates in a manner substantially similar to the tactile input hardware 126a, i.e., the peripheral tactile input 126b includes movable objects and transforms motion of the movable objects into a data signal that may be transmitted over the communication path 204.

As noted above, the speech recognition system 100 includes the microphone 120 for transforming acoustic vibrations received by the microphone into a speech input signal. The microphone 120 is coupled to the communication path 204 and communicatively coupled to the one or more processors 132. As will be described in further detail below, the one or more processors 132 may process the speech input signals received from the microphone 120 and/or extract speech information from such signals.

Still referring to FIG. 2, the speech recognition system 100 includes the activation switch 128 for activating or interacting with the speech recognition system 100. In some embodiments, the activation switch 128 is an electrical switch that generates an activation signal when depressed, such as when the activation switch 128 is depressed by a user when the user desires to utilize or interact with the speech recognition system 100.

As noted above, the speech recognition system 100 includes the network interface hardware 218 for communicatively coupling the speech recognition system 100 with a mobile device 220 or a computer network. The network interface hardware 218 is coupled to the communication path 204 such that the communication path 204 communicatively couples the network interface hardware 218 to other modules of the speech recognition system 100. The network interface hardware 218 can be any device capable of transmitting and/or receiving data via a wireless network. Accordingly, the network interface hardware 218 can include a communication transceiver for sending and/or receiving data according to any wireless communication standard. For example, the network interface hardware 218 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 218 includes a Bluetooth transceiver that enables the speech recognition system 100 to exchange information with the mobile device 220 (e.g., a smartphone) via Bluetooth communication.

Still referring to FIG. 2, data from various applications running on the mobile device 220 may be provided from the mobile device 220 to the speech recognition system 100 via the network interface hardware 218. The mobile device 220 may be any device having hardware (e.g., chipsets, processors, memory, etc.) for communicatively coupling with the network interface hardware 218 and a cellular network 222. Specifically, the mobile device 220 may include an antenna for communicating over one or more of the wireless computer networks described above. Moreover, the mobile device 220 may include a mobile antenna for communicating with the cellular network 222. Accordingly, the mobile antenna may be configured to send and receive data according to a mobile telecommunication standard of any generation (e.g., 1G, 2G, 3G, 4G, 5G, etc.). Specific examples of the mobile device 220 include, but are not limited to, smart phones, tablet devices, e-readers, laptop computers, or the like.

The cellular network 222 generally includes a plurality of base stations that are configured to receive and transmit data according to mobile telecommunication standards. The base stations are further configured to receive and transmit data over wired systems such as public switched telephone network (PSTN) and backhaul networks. The cellular network 222 can further include any network accessible via the backhaul networks such as, for example, wide area networks, metropolitan area networks, the Internet, satellite networks, or the like. Thus, the base stations generally include one or more antennas, transceivers, and processors that execute machine readable instructions to exchange data over various wired and/or wireless networks.

Accordingly, the cellular network 222 can be utilized as a wireless access point by the mobile device 220 to access one or more servers (e.g., a first server 224 and/or a second server 226). The first server 224 and second server 226 generally include processors, memory, and chipset for delivering resources via the cellular network 222. Resources can include providing, for example, processing, storage, software, and information from the first server 224 and/or the second server 226 to the speech recognition system 100 via the cellular network 222. Additionally, it is noted that the first server 224 or the second server 226 can share resources with one another over the cellular network 222 such as, for example, via the wired portion of the network, the wireless portion of the network, or combinations thereof

Still referring to FIG. 2, the one or more servers accessible by the speech recognition system 100 via the communication link of the mobile device 220 to the cellular network 222 may include third party servers that provide additional speech recognition capability. For example, the first server 224 and/or the second server 226 may include speech recognition algorithms and phonetic data for recognizing more words than the local speech recognition algorithms and phonetic data stored in the one or more memory components 134. It should be understood that the mobile device 220 may be communicatively coupled to any number of servers by way of the cellular network 222.

The speech recognition system 100 may include a satellite antenna 230 coupled to the communication path 204 such that the communication path 204 communicatively couples the satellite antenna 230 to other modules of the speech recognition system 100. The satellite antenna 230 is configured to receive signals from global positioning system satellites. Specifically, in one embodiment, the satellite antenna 230 includes one or more conductive elements that interact with electromagnetic signals transmitted by global positioning system satellites. The received signal is transformed into a data signal indicative of the location (e.g., latitude and longitude) of the satellite antenna 230 or an object positioned near the satellite antenna 230, by the one or more processors 132. Additionally, it is noted that the satellite antenna 230 may include at least one of the one or more processors 132 and the one or memory components 134. In embodiments where the speech recognition system 100 is coupled to a vehicle, the one or more processors 132 execute machine readable instructions to transform the global positioning satellite signals received by the satellite antenna 230 into data indicative of the current location of the vehicle. While the speech recognition system 100 includes the satellite antenna 230 in the embodiment depicted in FIG. 2, the speech recognition system 100 may not include the satellite antenna 230 in other embodiments, such as embodiments in which the speech recognition system 100 does not utilize global positioning satellite information or embodiments in which the speech recognition system 100 obtains global positioning satellite information from the mobile device 220 via the network interface hardware 218.

Still referring to FIG. 2, it should be understood that the speech recognition system 100 can be formed from a plurality of modular units, i.e., the display 124, the speaker 122, tactile input hardware 126a, the peripheral tactile input 126b, the microphone 120, the activation switch 128, etc. can be formed as modules that when communicatively coupled form the speech recognition system 100. Accordingly, in some embodiments, each of the modules can include at least one of the one or more processors 132 and/or the one or more memory components 134. Accordingly, it is noted that, while specific modules may be described herein as including a processor and/or a memory module, the embodiments described herein can be implemented with the processors and memory modules distributed throughout various communicatively coupled modules.

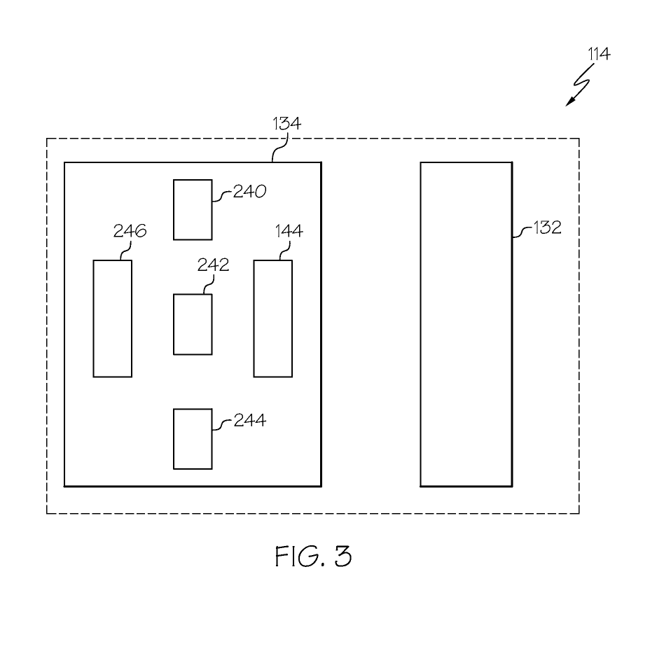

Referring now to FIG. 3, a schematic illustration of components of the speech recognition system 100 is shown, focusing on the vehicle computing device 114. The vehicle computing device 114 can provide the computing functions for the speech recognition system 100, as indicated above. For example, the vehicle computing device may include the memory component 134 having the speech and language logic 144 and multiple language-specific inventories 240, 242 and 244 that are used by the speech and language logic and the processor 132 for automatic speech recognition (ASR).

The language inventories 240, 242 and 244 may be formed of one or more component inventories, and may generally include vocabulary data and phonetic data. Phonetic data links words to their pronunciations and is used by the speech and language logic 144 to identify words based on the spoken commands of the user. Each language inventory 204, 242 and 244 may be associated with a different language. For example, language inventory 204 may be associated with English, language inventory 242 may be associated with French and language inventory 244 may be associated with Spanish. While only three language inventories are shown, more or less than three language inventories may be used and associated with any of the languages spoken around the world. Further, while the inventories are shown separate for illustration, they may be combined. Customized language inventories may also be created and used.

The speech recognition system 100 may provide cross-language ASR capabilities. The speech recognition system 100 may provide the cross-language ASR capabilities via user-driven commands that cause the speech and language logic 144 to switch between the language inventories 240, 242 and 244 (e.g., from a preferred language inventory to a new language inventory) for recognizing the voice input. For example, a French speaking user having French as a preferred language for the speech recognition system 100 may have an opportunity to voice input English commands upon prompting by the speech recognition system 100 and acknowledgement by the user. Such an arrangement can facilitate various input driven features, such as searching for terms or addresses in a different language using map data 246, despite having another language as the preferred language. In some embodiments, although a different language inventory 240, 242, 244 may be used for ASR, the preferred language may continue to be used for output to the user, such as for display or sound output.

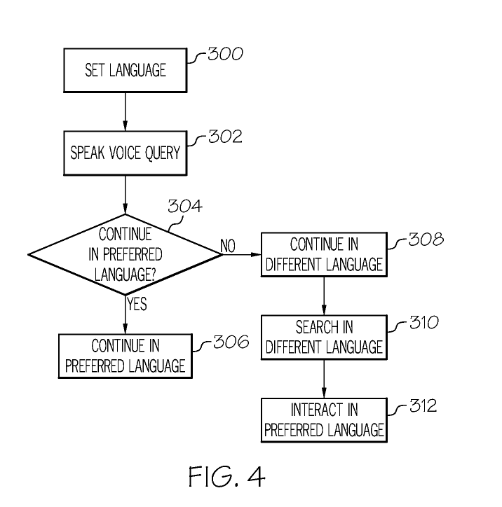

FIG. 4 illustrates a usage example illustrating operation of the cross-language ASR capabilities of the speech recognition system 100. At step 300, a preferred language may be set for the speech recognition system 100. A settings menu may be provided, for example, that allows the user to set various preferences, such as language. As one example, in Quebec, Canada the normal and everyday language of work, instruction, communication, commerce and business is French. Thus, it may be desirable for users in Quebec to set the preferred language of the speech recognition system 100 to French. Additionally, there may be other French-speaking users outside of Quebec who would prefer French, but reside in English-speaking regions. Such a language setting can allow the user to speak a voice query in that language at step 302. One such query may be an address search, as one example. For addresses in the preferred language, the speech recognition system 100 has a greater probability of automatically recognizing the voice query. However, for addresses in a different language, the probability of the speech recognition system 100 automatically recognizing the voice query decreases. Thus, at step 304 the speech recognition system 100 can prompt the user to continue in the preferred language, or a different language, such as English. If the address is a preferred language address, the user may select to continue via voice command in the preferred language at step 306 and the speech recognition system 100 may provide searching and speech interaction with the user in the preferred language. If the address is in a different language, the user may select to continue via voice command in the different language at step 308. Upon receipt of an address or keyword, the speech recognition system 100 may continue searching in the different language inventory and/or map data at step 310 and display the search results in the second language. In some embodiments, the speech recognition system 100 may search locally or remotely, for example, using the Internet and/or servers 224 and 226. Although the speech recognition system 100 may search and provide results in the different language, the speech recognition system 100 may continue to interact with the user (e.g., visually and through speech) in the preferred language at step 312.

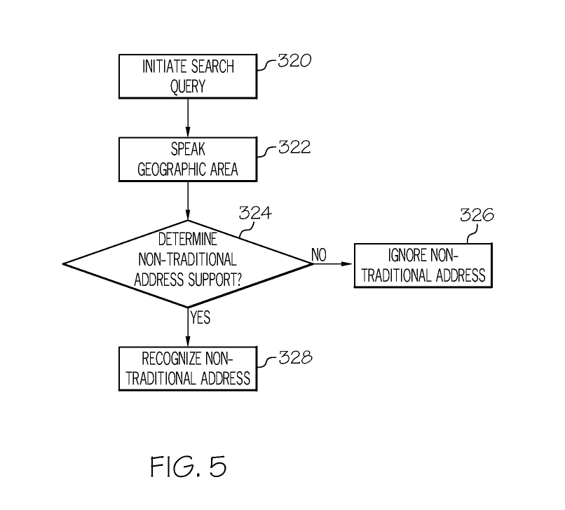

Referring to FIG. 5, in some embodiments, the speech recognition system 100 may be capable of recognizing non-traditional addresses, such as ANNN (an alpha character followed by one to three digits) and NNN-NNNN (one to three digits, a dash and then one to four digits). At step 320, a search query for an address may be initiated and the speech recognition system may prompt a user to speak or otherwise input a geographic region at step 322. At step 324, it is determined whether a spoken or otherwise entered geographic region (e.g., city and state) supports non-traditional addresses. If the geographical area is voice indicated by the user that does not include (or typically include) non-traditional addresses recognized by the speech recognition system 100 (e.g., using the memory component 134), the speech recognition system 100 may ignore any non-traditional address input at step 326. However, if a geographical area is voice indicated by the user is known by the speech recognition system to include non-traditional addresses, non-traditional addresses may be recognized by the speech recognition system 100 at step 328.

The above-described speech recognition systems can handle a variety of inputs, such as multiple languages and formats, and provide desired outputs based on the variety of inputs. The speech recognition systems may include logic that facilitates searching and other functions in multiple languages without changing language preferences. In some embodiments, the speech recognition systems may include logic that facilitates searching of addresses in non-traditional formats, such as irregular house addresses with dashes or other characters.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing cross-language automatic speech recognition, the method comprising:
choosing a preferred first language for a speech recognition system, the speech recognition system supporting multiple languages;
initiating a search operation using the speech recognition system;
prompting a user to continue the search operation in the first language or a second language; and
in response to the user selection of continuing in the second language, providing searching in the second language and providing interaction with the user in the first language during the search operation.

2. The method of claim 1, wherein the first language comprises French and the second language comprises English.

3. The method of claim 1 further comprising, in response to the user selection of continuing in the first language, providing searching and speech interaction with the user in the first language.

4. The method of claim 1 further comprising displaying search results in the second language.

5. The method of claim 1 further comprising searching for an address using the speech recognition system.

6. The method of claim 5, wherein the address is in Quebec, Canada.

7. The method of claim 1, wherein the speech recognition system is in a vehicle.

8. The method of claim 1 further comprising using phonetic data to recognize speech in the first and second languages.

9. An automatic speech recognition system that provides cross-language automatic speech recognition, the automatic speech recognition system comprising:
a computing device comprising one or more processors and one or more memory components, the computing device including speech and language logic that
in response to a user initiating a search operation, prompts the user to continue the search operation in a first language or a second language; and
in response to the user selection of continuing in the second language, provides searching in the second language and provides interaction with the user in the first language during the search operation.

10. The system of claim 9, wherein the first language comprises French and the second language comprises English.

11. The system of claim 9, wherein the speech and language logic, in response to the user selection of continuing in the first language, provides searching and speech interaction with the user in the first language.

12. The system of claim 9 further comprising a display, the computing device displaying search results on the display in the second language.

13. The system of claim 9, wherein the speech and language logic uses phonetic data to recognize speech in the first and second languages.

14. A method for providing cross-language automatic speech recognition, the method comprising:
initiating an address search operation using a speech recognition system, the speech recognition system having a preferred first language and supporting at least one other language;
prompting a user to continue the address search operation in the first language or the at least one other language after the address search is initiated; and
in response to the user selection of continuing in the at least one other language, providing searching in the at least one other language and providing interaction with the user in the first language.

15. The method of claim 14 further comprising searching in a language-specific inventory.

16. The method of claim 14, wherein the first language comprises French and the at least one other language comprises English.

17. The method of claim 14 further comprising, in response to the user selection of continuing in the first language, providing searching and speech interaction with the user in the first language.

18. The method of claim 14 further comprising the speech recognition system determining if a geographic region input by the user supports at least one non-traditional address format.

19. The method of claim 14, wherein the speech recognition system is in a vehicle.

20. The method of claim 14 further comprising using phonetic data to recognize speech in the first and at least one other language.
